(19) United States
(12) Patent Application Publication
(10) Pub. No.: US 2008/0023864 A1
(43) Pub. Date: Jan. 31, 2008

(54) Molding-Machine Supply-Energy Calculation Apparatus, Molding-Machine Control Apparatus, and Molding-Machine Control Method

(75) Inventor: Noritaka Okada, Chiba (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 11/660,930

(22) PCT Filed: Aug. 25, 2005
(86) PCT No.: PCT/JP05/15413

§ 371 Date: Feb. 23, 2007

(30) Foreign Application Priority Data
Aug. 25, 2004 (JP) 2004-244528

(51) Int. Cl. B29C 45/76

(52) U.S. Cl. 264/40.1; 425/135; 425/143

(57) ABSTRACT

An object is to enable accurate calculation of the energy supplied to a cylinder member and enable properly changing the supply energy in accordance with the type of molding material. A molding-machine supply-energy calculation apparatus includes a high-frequency-current generation circuit including a coil (16) disposed on a cylinder member, a DC voltage generation circuit (31), switching elements, and capacitors (C1 to C4), and adapted to generate high frequency current through switching of the switching elements and supply the current to the coil (16); an electrical variable detection section that detects an electrical variable representing a state of a resonance circuit (SR2); drive-signal generation processing section that generates drive signals (g1, g2) driving the switching elements on the basis of the electrical variable; and supply-energy calculation processing section that calculates the energy supplied to the cylinder member on the basis of a voltage generated by the DC voltage generation circuit (31), the capacitance of the capacitors (C3, C4), and the electrical variable. It becomes unnecessary to take the loss associated with switching of the switching elements into consideration.

### TECHNICAL FIELD

The present invention relates to a molding-machine supply-energy calculation apparatus, a molding-machine control apparatus, and a molding-machine control method.

### BACKGROUND ART

Conventionally, in a molding machine; for example, in an injection-molding machine, resin (molding material) melted in an injection apparatus is charged into a cavity of a mold apparatus, so as to mold a product. For such molding, a heating cylinder serving as a cylinder member is provided in the injection apparatus, and electricity is supplied to a heater disposed around the heating cylinder so as to melt the resin within the heating cylinder. The temperature of the heating cylinder is detected, and the heater is turned on and off on the basis of the detected temperature, whereby feedback control is performed (see, for example, Patent Document 1).

Patent Document 1: Japanese Patent Application Laid-Open (kokai) No. H6-328510.

### DISCLOSURE OF THE INVENTION

### Problems to be Solved by the Invention

However, in the conventional injection apparatus, since the heating cylinder is heated through supply of electricity to the heater so as to indirectly heat the resin, a large amount of heat is radiated from the heater, so that the heating efficiency cannot be increased.

In order to overcome this drawback, an induction heating apparatus can be used. In the induction heating apparatus, instead of the heater, a coil is disposed around the heating cylinder, and current is supplied to the coil so as to heat the heating cylinder by means of induction heating. In this case, the temperature of the heating cylinder is detected, and a duty ratio of the induction heating, which is a time ratio between a period during which the induction heating is performed and a period during which the induction heating is stopped, is changed on the basis of the detected temperature, whereby feedback control is performed.

However, in the above-mentioned induction heating apparatus, since supply energy (watt density) to the heating cylinder, which represents the heating capacity during a period in which the induction heating is performed, is constant, when the resin is changed, the supply energy must be changed in accordance with the type of the resin. In this case, the voltage of the DC voltage generation circuit of the induction heating apparatus and time-averaged current are measured, and the supply energy is calculated on the basis of the measurement results. Notably, the supply energy corresponds to the quantity of heat supplied to the heating cylinder.

However, in this case, it is impossible to take into consideration the loss associated with switching of switching elements in the induction heating apparatus, and to accurately measure the time-averaged current, because the high-frequency current generated in the induction heating apparatus flows into the DC voltage generation current. Accordingly, the supply energy cannot be accurately calculated, with the result that the supply energy cannot be changed properly in accordance with, for example, the type of resin.

An object of the present invention is to solve the above-mentioned problems in the conventional induction heating apparatus and to provide a molding-machine supply-energy calculation apparatus, a molding-machine control apparatus, and a molding-machine control method, which enable accurate calculation of the energy supplied to a cylinder member and enable properly changing the supply energy in accordance with the type of molding material.

### Means for Solving the Problems

In order to achieve the above object, a molding-machine supply-energy calculation apparatus of the present invention comprises a high-frequency-current generation circuit including a coil disposed on a cylinder member, a DC voltage generation circuit, a switching element, and a capacitor, and adapted to generate high frequency current through switching of the switching element and supply the current to the coil; an electrical variable detection section that detects an electrical variable representing a state of a resonance circuit formed by the coil and the capacitor; drive-signal generation processing section that generates a drive signal driving the switching element on the basis of the electrical variable; and supply-energy calculation processing section that calculates an energy supply to the cylinder member on the basis of a voltage generated by the DC voltage generation circuit, a capacitance of the capacitor, and the electrical variable.

### EFFECT OF THE INVENTION

According to the present invention, a molding-machine supply-energy calculation apparatus comprises a high-frequency-current generation circuit including a coil disposed on a cylinder member, a DC voltage generation circuit, a switching element, and a capacitor, and adapted to generate high frequency current through switching of the switching element and supply the current to the coil; an electrical variable detection section that detects an electrical variable representing a state of a resonance circuit formed by the coil and the capacitor; drive-signal generation processing section that generates a drive signal driving the switching element on the basis of the electrical variable; and supply-energy calculation processing section that calculates an energy supply to the cylinder member on the basis of a voltage generated by the DC voltage generation circuit, a capacitance of the capacitor, and the electrical variable.

In this case, since the energy supplied to the cylinder member is calculated on the basis of the voltage generated by the DC voltage generation circuit, the capacitance of the capacitor, and the electrical variable, consideration of the loss associated with switching of the switching element becomes unnecessary, and the supply energy can be accurately calculated even when high frequency current flows to the DC voltage generation circuit. Accordingly, for example, when the molding material is changed, the supply energy can be properly changed in accordance with the type of the molding material.

### BRIEF DESCRIPTION OF DRAWINGS

FIG. 1 is a conceptual diagram of an induction heating apparatus according to a first embodiment of the present invention.

FIG. 2 is a block diagram showing a main portion of an injection-molding-machine control apparatus according to the first embodiment of the present invention.

FIG. 3 is a diagram showing operation of an inverter in the first embodiment of the present invention.

FIG. 4 is a time chart representing the relation between input voltage and detection voltage of the induction heating apparatus according to the first embodiment of the present invention.

FIG. 5 is a conceptual diagram of an induction heating apparatus according to a second embodiment of the present invention.

FIG. 6 is a diagram showing operation of an inverter in the second embodiment of the present invention.

FIG. 7 is a time chart representing changes in accumulated energy in the second embodiment of the present invention.

FIG. 8 is a time chart representing the relation between input voltage and detection voltage of the induction heating apparatus according to the second embodiment of the present invention.

FIG. 9 is a block diagram showing a main portion of an injection-molding-machine control apparatus according to a third embodiment of the present invention.

FIG. 10 is a conceptual diagram of an induction heating apparatus according to a fourth embodiment of the present invention.

FIG. 11 is a diagram showing operation of an inverter in the fourth embodiment of the present invention.

FIG. 12 is a time chart representing the relation between input voltage and voltage change rate of the induction heating apparatus according to the fourth embodiment of the present invention.

FIG. 13 is a conceptual diagram of an induction heating apparatus according to a fifth embodiment of the present invention.

FIG. 14 is a diagram showing operation of an inverter in the fifth embodiment of the present invention.

FIG. 15 is a time chart representing the relation between input voltage and current of the induction heating apparatus according to the fifth embodiment of the present invention.

### DESCRIPTION OF SYMBOLS

12: heating cylinder
14: induction heating apparatus
16: coil
21: temperature sensor
25: PID compensator
28: supply energy calculation section
31: DC voltage generation circuit
36: current sensor
AN1: voltage detection section
AN2, AN3: inverter
AN5: buffer
C1-C4: capacitor
OP1: comparator
Q1, Q2: IGBT
SR1: operation output section
SR2: resonance circuit

### BEST MODE FOR CARRYING OUT THE INVENTION

The embodiments of the present invention will next be described in detail with reference to the drawings. Here, there will be described an injection-molding-machine control apparatus, which is a molding-machine control apparatus and which is applied to an injection-molding machine, which is one type of a molding machine.

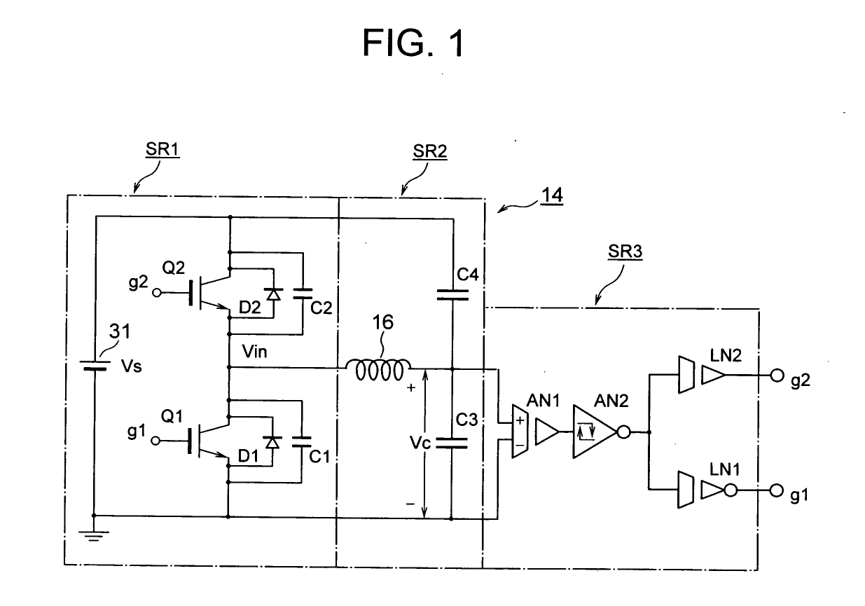

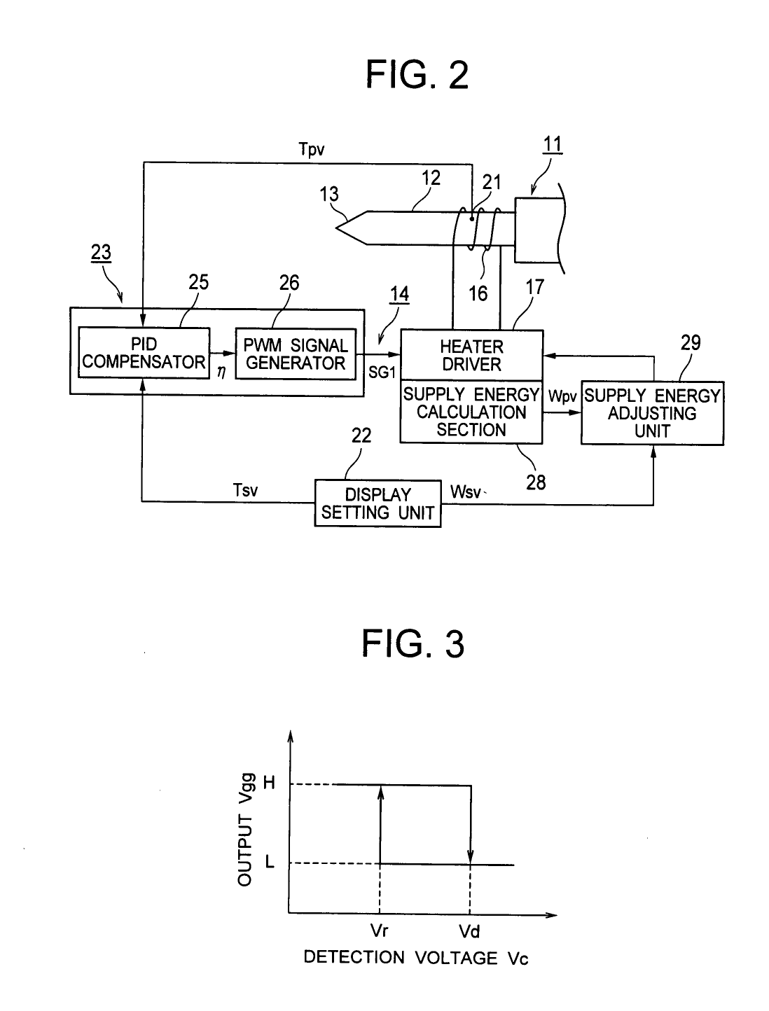

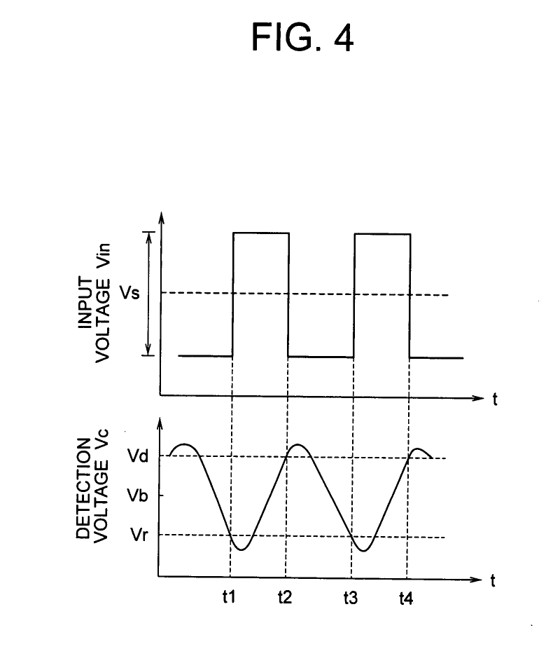

FIG. 1 is a conceptual diagram of an induction heating apparatus according to a first embodiment of the present invention. FIG. 2 is a block diagram showing a main portion of an injection-molding-machine control apparatus according to the first embodiment of the present invention. FIG. 3 is a diagram showing operation of an inverter in the first embodiment of the present invention. FIG. 4 is a time chart representing the relation between input voltage and detection voltage of the induction heating apparatus according to the first embodiment of the present invention. In FIG. 3, the horizontal axis represents detection voltage Vc, and the vertical axis represents output.

In FIG. 2, reference numeral 11 denotes an injection apparatus, which constitutes an injection molding machine in cooperation with an unillustrated mold clamping apparatus, an unillustrated mold apparatus, etc. The injection apparatus 11 includes a heating cylinder (cylinder member) 12 for heating and melting resin (molding material) supplied from an unillustrated hopper, an injection nozzle 13 for injecting the molten resin, etc. An unillustrated screw is disposed within the heating cylinder 12 such that the screw can advance, retreat, and rotate. When the screw is advanced through drive of an unillustrated injection motor, the resin is injected from the injection nozzle 13. When the screw is rotated through drive of an unillustrated metering motor with the resultant retreat, metering of the resin is performed.

The injected resin is charged into a cavity of the mold apparatus, and cooled within the cavity, whereby a molded product is produced.

In this case, an induction heating apparatus 14 is provided so as to heat and melt the resin. The induction heating apparatus 14 includes a coil 16 disposed on the heating cylinder 12; a heater driver 17 which generates high frequency current (current for induction heating) and supplies it to the coil 16; a temperature sensor (temperature detection section) 21 disposed on the heating cylinder 12 at a predetermined location so as to detect the temperature of the heating cylinder 12; a display setting unit 22 which serves as a display section and a setting section; and a control section 23 which reads a detection temperature Tpv; i.e., the temperature detected by means of the temperature sensor 21 and a set temperature Tsv; i.e., a target temperature of the heating cylinder 12 set by means of the display setting unit 22 and drives the heater driver 17 so as to perform feedback control.

The control section 23 includes a PID compensator 25, a PWM signal generator 26, etc. The PID compensator 25 calculates a proportional component, an integral component, and a derivative component on the basis of the difference ΔT between the detection temperature Tpv and the set temperature Tsv (ΔT=Tsv−Tpv), and calculates an induction heating duty ratio η on the basis of the calculation result. The PWM signal generator 26 generates a PWM signal SG1 on the basis of the duty ratio η and sends it to the heater driver 17. The PWM signal SG1 is maintained at a low level during periods in which the heater driver 17 is to be driven, and is maintained at a high level during periods in which the heater driver 17 is to be stopped.

The display setting unit 22 includes a display, a liquid crystal panel, LEDs, lamps, a warning device, etc. as a display section, and also includes an operation panel, keys, switches, etc. as a setting section. The display setting unit 22 enables an operator to set the above-mentioned set temperature Tsv by operating the setting section, and displays the detection temperature Tpv and the set temperature Tsv at the display section.

In the present embodiment, the supply energy to the heating cylinder 12 is calculated, and the supply energy to the heating cylinder 12 is controlled such that the calculated supply energy coincides with a set supply energy Wsv, which is the target supply energy. For such control, the present embodiment includes a supply energy calculation section 28, which serves as supply-energy calculation processing means (processing section), and a supply energy adjusting unit 29, which serves as supply-energy adjustment processing means (processing section). The set supply energy Wsv can be set by use of the display setting unit 22.

The supply energy calculation section 28 performs supply-energy calculation processing, to thereby calculate the actual supply energy Wpv to the heating cylinder 12. The supply energy adjusting unit 29 performs supply-energy adjustment processing for changing oscillation control parameters, such as oscillation frequency, used in the heater driver 17, so as to adjust the supply energy Wpv such that the supply energy Wpv coincides with the set supply energy Wsv. Further, the supply energy adjusting unit 29 can change the voltage Vs output from a circuit which forms a power supply circuit of the heater driver 17 and generates a DC voltage; i.e., a DC voltage generation circuit. Notably, the induction heating apparatus 14 and the supply energy calculation section 28 constitute a molding-machine supply-energy calculation apparatus.

Next, the details of the induction heating apparatus 14 will be described.

In FIG. 1, SR1 denotes an operation output section, SR2 denotes a resonance circuit, and SR3 denotes a drive signal generation section. The operation output section SR1 includes a DC voltage generation circuit 31; two IGBTs (switching elements) Q1 and Q2 connected in series to the DC voltage generation circuit 31; and diodes D1 and D2 and capacitors C1 and C2 connected between the emitters and correctors of the IGBTs Q1 and Q2; etc. Notably, in place of the IGBTs Q1 and Q2, other types of transistors can be used. The DC voltage generation circuit 31 is configured such that the voltage Vs output therefrom can be changed, and is grounded at its negative terminal. Drive signals g1 and g2 are input to the bases of the IGBTs Q1 and Q2, respectively.

The resonance circuit SR2 includes a coil 16 whose one end is connected to a line between the IGBTs Q1 and Q2; and two capacitors C3 and C4 which are connected between the other end of the coil 16 and the negative and positive terminals, respectively, of the DC voltage generation circuit 31. The inter-terminal voltage of one of the capacitors C3 and C4 (the capacitor C3 in the present embodiment) is detected, as a detection voltage Vc, by means of an unillustrated voltage sensor (voltage detection element), and is fed to the supply energy calculation section 28. The detection voltage Vc serves as an electrical variable representing the state of the resonance circuit SR2. The voltage sensor serves as an electrical variable detection section. The operation output section SR1 and the resonance circuit SR2 constitute a high-frequency-current generation circuit.

In this case, current of a frequency higher than the frequency (50 Hz or 60 Hz) of commercial current supplied from a commercial power source can be used as the high frequency current. However, use of current having a frequency of about 100 Hz lowers the heating efficiency of the coil 16. Therefore, use of current having a frequency of 500 Hz or higher is preferred. However, when current having a frequency of 200 kHz or higher is used, switching by means of the IGBTs Q1 and Q2 becomes difficult. Accordingly, use of current having a frequency not lower than 5 kHz but not greater than 100 kHz is preferred.

When high frequency current is supplied to the coil 16, induced current is generated in the heating cylinder 12, and Joule heat is generated because of eddy-current loss attributable to the induced current, whereby the heating cylinder 12 is heated. In the present embodiment, the heating cylinder 12 is formed of a paramagnetic material. However, the heating cylinder 12 is preferably formed of a metallic material which can concentrate induction current to the surface and increase the heat generation amount at the heating cylinder 12; e.g., steel, which is a ferromagnetic material.

The drive signal generation section SR3 is designed to generate the drive signals g1 and g2. The drive signal generation section SR3 includes a voltage detection section AN1 which is connected between the opposite ends of the capacitor C3 together with the above-described voltage sensor and detects the inter-terminal voltage as a detection voltage Vc; an inverter AN2 connected to the output terminal of the voltage detection section AN1 and serving as drive-signal generation processing means (processing section); first and second buffers LN1 and LN2 connected to the output terminal of the inverter AN2 and outputting the output Vgg of the inverter AN2 as the drive signals g1 and g2; etc. Notably, the voltage detection section AN1 constitutes an electrical variable detection section. In the present embodiment, the voltage sensor and the voltage detection section AN1 are provided as the electrical variable detection section. However, it may be the case that only the voltage detection section AN1 is provided. The first buffer LN1 has an inverting function, so that the drive signal g1 is inverted in relation to the drive signal g2; i.e., the drive signal g1 is at the low level when the drive signal g2 is at the high level, and is at the high level when the drive signal g2 is at the low level. The voltage detection section AN1 and the first and second buffers LN1 and LN2 each have an isolation structure, and provide electrical isolation between the operation output section SR1 and the resonance circuit SR2 of the high-energy power system and the inverter AN2 of the low-energy power system. The term “high-energy power system” refers to a circuit in which electrical power is used as energy, and the term “low-energy power system” refers to a circuit in which electrical power is used as a signal.

In order to generate the above-described high frequency current, the drive signals g1 and g2 must be input to the IGBTs Q1 and Q2 at all times. In the present embodiment, in an initial state, the level of the drive signal g2 is switched from the low level to the high level at a predetermined timing, while the drive signal g1 is maintained at the low level, whereby the IGBT Q2 is turned on with the IGBT Q1 maintained off. As a result, the input voltage Vin becomes a high level, and current flows from the DC voltage generation circuit 31 to the coil 16 via the IGBT Q2, whereby the capacitor C3 is charged, and the inter-terminal voltage of the capacitor C3 and the detection voltage Vc increase gradually.

The inverter AN2, which performs drive-signal generation processing, receives the detection voltage Vc, and operates in accordance with the operation characteristic as shown in FIG. 3. That is, in a case where the detection voltage Vc increases with the output being at the high level (H), the output remains at the high level until the detection voltage Vc reaches a voltage Vd, which serves as a first threshold voltage, changes from the high level to the low level (L) when the detection voltage Vc reaches the voltage Vd, and remains at the low level after that point. Meanwhile, in a case where the detection voltage Vc decreases with the output being at the low level, the output remains at the low level until the detection voltage Vc reaches a voltage Vr, which is set to be lower than the voltage Vd and serves as a second threshold voltage, changes from the low level to the high level when the detection voltage Vc reaches the voltage Vr, and remains at the high level after that point. Notably, the above-described voltages Vd and Vr, which the supply energy adjusting unit 29 calculates on the basis of the set supply energy Wsv, serve as supply energy calculation variables for calculating the supply energy Wpv.

Accordingly, as shown in FIG. 4, when the detection voltage Vc gradually decreases after having reached a peak value and reaches the voltage Vr at timing t1 (t3), the output Vgg of the inverter AN2 assumes the high level, the drive signal g1, which is the output of the first buffer LN1, assumes the low level, and the drive signal g2, which is the output of the second buffer LN2, assumes the high level.

As a result, the IGBT Q1 is turned off, and the IGBT Q2 is turned on, so that the input voltage Vin changes from the low level to the high level, the capacitor C4 is discharged, and the capacitor C3 is charged, during which current flows through the coil 16 via the IGBT Q2. The inter-terminal voltage of the capacitor C3 and the detection voltage Vc increase gradually after having reached a bottom value.

Meanwhile, when the detection voltage Vc gradually increases and reaches the voltage Vd at timing t2 (t4), the output Vgg of the inverter AN2 assumes the low level, the drive signal g1 assumes the high level, and the drive signal g2 assumes the low level.

As a result, the IGBT Q1 is turned on, and the IGBT Q2 is turned off, so that the input voltage Vin changes from the high level to the low level, the capacitor C3 is discharged, and the capacitor C4 is charged, during which current flows through the coil 16 via the IGBT Q1. The inter-terminal voltage of the capacitor C3 and the detection voltage Vc decrease gradually after having reached a peak value.

As shown in FIG. 4, the input voltage Vin assumes a rectangular waveform, and the detection voltage Vc assumes a waveform resembling the sinusoidal waveform. The drive signal g2 assumes a rectangular waveform similar to that of the input voltage Vin, and the drive signal g1 assumes a rectangular waveform which is inverse of that of the drive signal g2. The input voltage Vin is applied to the coil 16, and the drive signals g1 and g2 are input to the IGBTs Q1 and Q2, respectively.

The amplitude of the input voltage Vin between the high level and the low level is generally equal to the voltage Vs of the DC voltage generation circuit 31.

When the waveform of the detection voltage Vc is stable, the frequency f of the high-frequency-current generation circuit is represented by as follows:

$$f = \frac{1}{2 π \sqrt{( L \cdot C )}}$$

where L represents the inductance of the coil 16, and C represents the total capacitance of the capacitors C3 and C4.

When the detection voltage Vc, which is the voltage applied to one of the capacitors C3 and C4 (the capacitor C3 in the present embodiment), is determined, since the change rate of the detection voltage Vc is equal to that of the voltage applied to the capacitor C4, the current I_{L} flowing through the coil 16 is represented as follows.

$${I}_{L} = C \cdot \frac{ⅆ Vc}{ⅆ t}$$

The supply energy Wpv to the heating cylinder 12 is equal to the energy consumed at the coil 16, and is represented as follows.
WPv=∫Vin·I_{L}·dt
As shown in FIG. 4, the input voltage Vin assumes either the high level or the low level. When the energy consumed by the coil 16 when the input voltage Vin is at the high level is represented by PH, the energy PH can be obtained as follows.
PH=Σ∫_{Vin=Vs}Vs·I_{L}·dt
When the energy consumed by the coil 16 when the input voltage Vin is at the low level is represented by PL, the energy PL can be obtained as follows.
PL=Σ∫_{Vin=0}0·I_{L}·dt=0
Notably, the value ∫_{Vin=Vs}Vs·I_{L}·dt represents the energy consumed at the coil 16 during a single cycle.

The supply energy calculation section 28 calculates the supply energy Wpv as follows on the basis of the voltage Vs, the capacitance C, and the detection voltage Vc.

$$\begin{matrix}Wpv = PH \\ = \sum {\int }_{Vin = Vs} Vs \cdot {I}_{L} \cdot ⅆ t \\ = \sum {\int }_{Vin = Vs} Vs \cdot C \cdot \frac{ⅆ Vc}{ⅆ t} \cdot ⅆ t \\ = \sum Vs \cdot C \cdot {\int }_{Vin = Vs} ⅆ Vc\end{matrix}$$

Here, the value ∫_{Vin=Vs}dVc represents the change amount of the detection voltage Vc during each period in which the input voltage Vin is at the high level, and is represented as follows.
∫_{Vin=Vs}dVc=(Vd−Vr)
Therefore, the supply energy Wpv can be represented as follows.
Wpv=ΣVs·C·(Vd−Vr) (1)

Since the base frequency f of switching assumes a substantially constant value when the waveform of the detection voltage Vc is stable, the energy P supplied to the heating cylinder 12 per unit time can be calculated by the following equation at the supply energy calculation section 28.
P=f·Vs·C·(Vd−Vr) (2)

Accordingly, the set supply energy Wsv can be set on the basis of the supply energy P per unit time.

Incidentally, when a predetermined voltage is set as a reference voltage Vb for the detection voltage Vc, the supply energy Wpv can be calculated as follows at the supply energy calculation section 28. Notably, in the present embodiment, when the capacitances of the capacitors C3 and C4 are equal to each other, preferably, the relation Vd−Vb=Vb−Vr is satisfied.

In this case, the supply energy Wpv is calculated as follows. That is, every time the detection voltage Vc reaches Vr and the input voltage Vin rises from the low level to the high level, an energy Pr (Pr=Vs·C·(Vb−Vr)) is added so as to calculate a cumulative value ΣPr; and every time the detection voltage Vc reaches Vd and the input voltage Vin drops from the high level to the low level, an energy Pd (Pd=Vs·C·(Vd−Vb)) is added so as to calculate a cumulative value ΣPd. The supply energy Wpv can be obtained as follows.

$$\begin{matrix}Wpv = \sum Pr + \sum Pd \\ = \sum Vs \cdot C \cdot ( Vb - Vr ) + \sum Vs \cdot C \cdot ( Vd - Vb ) \\ = \sum Vs \cdot C \cdot ( Vd - Vr )\end{matrix} \qquad ( 3 )$$

The thus-obtained supply energy Wpv becomes equal to the supply energy Wpv of Equation (1). In this manner, the supply energy Wpv is calculated by the supply energy calculation section 28.

As described above, the supply energy Wpv is calculated on the basis of the detection voltage Vc, the capacitance C, the reference voltage Vb, and the voltages Vd and Vr without use of time-averaged current, which represents the mean value of current flowing through the DC voltage generation circuit 31. Therefore, consideration of the loss associated with switching of the IGBTs Q1 and Q2 becomes unnecessary, and the supply energy Wpv can be accurately calculated even when high frequency current generated by the induction heating apparatus 14 flows to the DC voltage generation circuit 31. Accordingly, for example, when the molding material is changed, the supply energy Wpv can be properly changed by changing the voltages Vd and Vr. In addition, the supply energy Wpv can be properly changed by changing the voltage Vs in accordance with the type of the resin.

Incidentally, in an initial state, the level of the drive signal g2 is raised from the low level to the high level at a predetermined timing t0, while the drive signal g1 is maintained at the low level, and subsequently, the levels of the drive signals g1 and g2 are changed to each assume a rectangular waveform similar to that of the input voltage Vin shown in FIG. 4. However, at the initial state, the drive signals g1 and g2 can be generated to each assume a rectangular waveform.

In this case, the drive signals g1 and g2 are generated at a base frequency fa such that they have a constant pulse width and assume the high and low levels alternately. Therefore, the input voltage Vin to the coil 16 is also generated at the frequency fa such that it has a constant pulse width and assumes the high and low levels alternately.

Therefore, the supply energy calculation section 28 reads the detection voltage Vc at a timing when the input voltage Vin raises from the low level to the high level and stores it as the voltage Vr; reads the detection voltage Vc at a timing when the input voltage Vin drops from the high level to the low level and stores it as the voltage Vd; and calculates the supply energy Wpv on the basis of the above-described Equations (1) and (3), and the supply energy P on the basis of the above-described Equation (2).

In this case, the supply energy adjusting unit 29 can not only change the supply energy Wpv by changing the voltage Vs, but change the supply energy P by changing the frequency fa.

Next, there will be described a second embodiment which can evaluate the supply energy Wpv to the heating cylinder 12 and change the supply energy Wpv on the basis of the evaluation results. Notably, components having the same structures as those in the first embodiment are denoted by the same reference numerals, and their repeated descriptions are omitted. For the effect that the second embodiment yields through employment of the same structure, the description of the effect of the first embodiment is incorporated herein by reference.

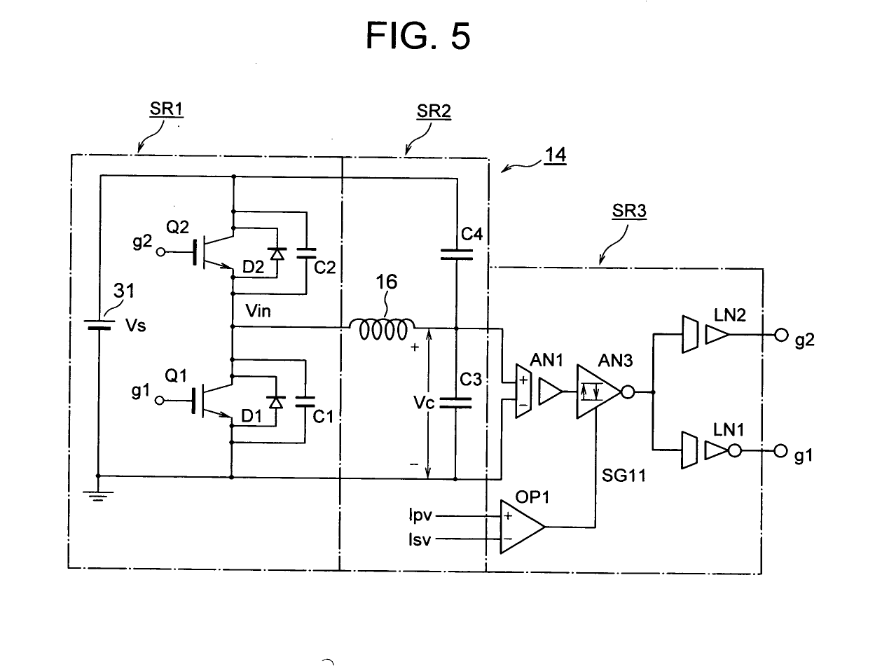

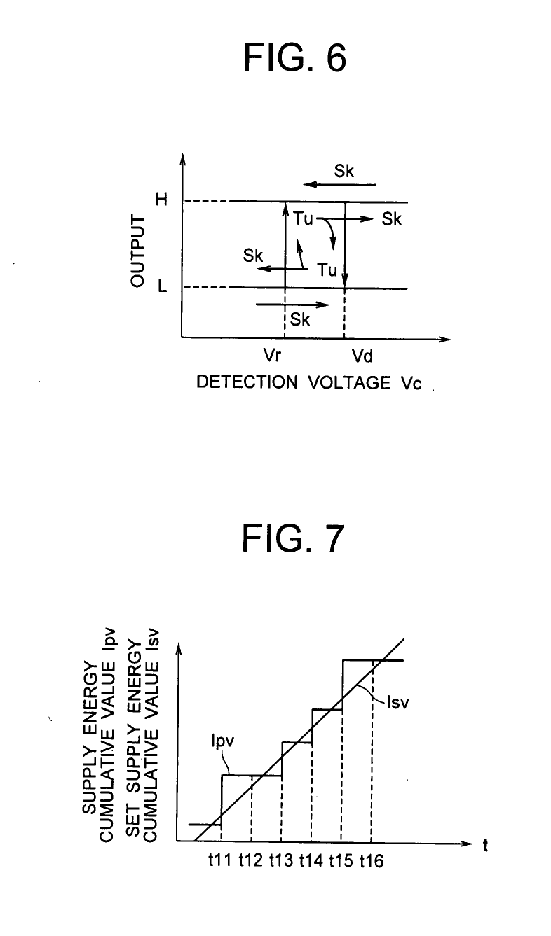

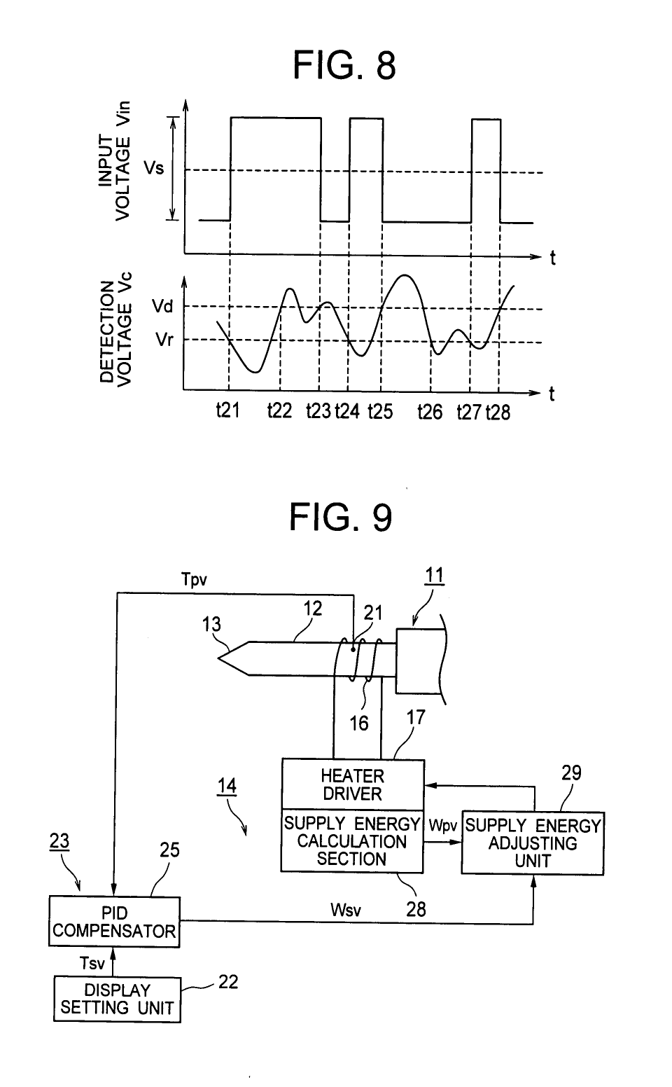

FIG. 5 is a conceptual diagram of an induction heating apparatus according to the second embodiment of the present invention. FIG. 6 is a diagram showing operation of an inverter in the second embodiment of the present invention. FIG. 7 is a time chart representing changes in accumulated energy in the second embodiment of the present invention. FIG. 8 is a time chart representing the relation between input voltage and detection voltage of the induction heating apparatus according to the second embodiment of the present invention. Notably, in FIG. 6, the horizontal axis represents the detection voltage Vc, and the vertical axis represents the output.

In this case, the inverter AN3, which is connected to the output terminal of the voltage detection section AN1 and serves as a drive-signal generation processing means (processing section), has a skip function, and the output terminal of a comparator OP1, which serves as a supply-energy-cumulative-value determination processing means (processing section), is connected to the inverter AN3. Notably, the voltage detection section AN1 constitutes an electrical variable detection section.

In the present embodiment, when the PWM signal SG1 fed from the control section 23 (FIG. 2) to the heater driver 17 first rises from the low level to the high level or when the temperature control for the heating cylinder 12, serving as a cylinder member, is started, the supply energy calculation section 28, which serves as supply-energy accumulation processing means (processing section) and supply-energy calculation processing means (processing section), performs supply-energy accumulation processing and supply-energy calculation processing so as to calculate the supply energy Wpv to the heating cylinder 12, and accumulate it every time switching of the IGBTs Q1 and Q2, which serves as switching elements, is performed, to thereby calculate the supply energy cumulative value Ipv. Further, when the supply-energy accumulation processing is started, the set supply energy Wsv is accumulated so as to calculate a set supply energy cumulative value Isv, which serves as a target for the supply energy cumulative value Ipv. The supply energy cumulative value Ipv and the set supply energy cumulative value Isv are input to the comparator OP1.

The comparator OP1 performs supply-energy-cumulative-value determination processing so as to compare the supply energy cumulative value Ipv and the set supply energy cumulative value Isv at each control timing, and send the comparison result to the inverter AN3 as a determination signal SG11. The determination signal SG11 is set to a high level when the supply energy cumulative value Ipv is greater than the set supply energy cumulative value Isv, and is set to a low level when the supply energy cumulative value Ipv is not greater than the set supply energy cumulative value Isv.

For example, as shown in FIG. 7, at timing t11 (t13-t15), the supply energy cumulative value Ipv is not greater than the set supply energy cumulative value Isv, so that the determination signal SG11 is set to the low level; and at timing t12 (t16), the supply energy cumulative value Ipv is greater than the set supply energy cumulative value Isv, so that the determination signal SG11 is set to the high level.

In the present embodiment, the supply energy cumulative value Ipv and the set supply energy cumulative value Isv are compared with each other. In actuality, a difference between the supply energy cumulative value Ipv and the set supply energy cumulative value Isv is recorded as a determination value in an unillustrated memory, serving as a recording apparatus, and the determination signal SG11 is generated on the basis of the determination value. In this case, at each control timing, the product of the set supply energy Wsv and the control period is added to the determination value, and the supply energy Wpv is subtracted from the determination value every time the switching of the IGBTs Q1 and Q2 is performed so as to change the determination value in the memory. The determination signal SG11 is set to the low level when the determination value is positive, and is set to the high level when the determination value is negative.

The inverter AN3, which performs drive-signal generation processing, receives the determination signal SG11 and the detection voltage Vc, which is the inter-terminal voltage of the capacitor C3 and serves as an electrical variable, and operates in accordance with the operation characteristic as shown in FIG. 6.

First, in a case where the detection voltage Vc increases with the output being at the high level (H), the output remains at the high level until the detection voltage Vc reaches a voltage Vd, which serves as a first threshold voltage. When the detection voltage Vc reaches the voltage Vd, the inverter AN3 performs a turn operation (Tu) or a skip operation (Sk), depending on whether or not the determination signal SG11 is at the high level. That is, when the determination signal SG11 is at the low level, the inverter AN3 performs the turn operation, whereby the output changes from the high level to the low level (L), and remains at the low level after that point. Meanwhile, when the determination signal SG11 is at the high level, the inverter AN3 performs the skip operation, whereby the output remains at the high level. In a case where the detection voltage Vc decreases with the output being at the high level, the inverter AN3 performs the skip operation, whereby the output remains at the high level irrespective of the above-mentioned voltage Vd and a voltage Vr, which is set to be lower than the voltage Vd and serves as a second threshold voltage. Notably, the above-described voltages Vd and Vr serve as the supply energy calculation variable.

Next, in a case where the detection voltage Vc decreases with the output being at the low level, the output remains at the low level until the detection voltage Vc reaches the voltage Vr. When the detection voltage Vc reaches the voltage Vr, the inverter AN3 performs the turn operation or the skip operation, depending on whether or not the determination signal SG11 is at the high level. That is, when the determination signal SG11 is at the low level, the inverter AN3 performs the turn operation, whereby the output changes from the low level to the high level, and remains at the high level after that point. Meanwhile, when the determination signal SG11 is at the high level, the inverter AN3 performs the skip operation, whereby the output remains at the low level. In a case where the detection voltage Vc increases with the output being at the low level, the inverter AN3 performs the skip operation, whereby the output remains at the low level irrespective of the above-mentioned voltages Vd and Vr.

Accordingly, since the inverter AN3 performs the turn operation when the determination signal SG11 is at the low level, as shown in FIG. 8, when the detection voltage Vc gradually decreases and reaches the voltage Vr at timing t21 (t24, t27), the output of the inverter AN3 assumes the high level, the drive signal g1, which is the output of the first buffer LN1, assumes the low level, and the drive signal g2, which is the output of the second buffer LN2, assumes the high level.

As a result, the IGBT Q1 is turned off, and the IGBT Q2 is turned on, so that the input voltage Vin changes from the low level to the high level, the capacitor C4 is discharged, and the capacitor C3 is charged, during which current flows through the coil 16 via the IGBT Q2. The inter-terminal voltage of the capacitor C3 and the detection voltage Vc increase gradually after having reached a bottom value.

Meanwhile, in the case where the determination signal SG11 is at the low level, when the detection voltage Vc gradually increases and reaches the voltage Vd at timing t23 (t25, t28), the output of the inverter AN3 assumes the low level, the drive signal g1 assumes the high level, and the drive signal g2 assumes the low level.

As a result, the IGBT Q1 is turned on, and the IGBT Q2 is turned off, so that the input voltage Vin changes from the high level to the low level, the capacitor C3 is discharged, and the capacitor C4 is charged, during which current flows through the coil 16 via the IGBT Q1. The inter-terminal voltage of the capacitor C3 and the detection voltage Vc decrease gradually after having reached a peak value.

In contrast, since the inverter AN3 performs the skip operation when the determination signal SG11 is at the high level, even when the detection voltage Vc gradually decreases and reaches the voltage Vr at timing t26, the output of the inverter AN3 does not change to the high level and remains at the low level. Thus, the drive signal g1 remains at the high level, and the drive signal g2 remains at the low level.

As a result, the IGBT Q1 is maintained on, and the IGBT Q2 is maintained off, so that the input voltage Vin remains at the low level.

Further, in a case where the determination signal SG11 is at the high level, even when the detection voltage Vc gradually increases and reaches the voltage Vd at timing t22, the output of the inverter AN3 remains at the high level. Thus, the drive signal g1 remains at the low level, and the drive signal g2 remains at the high level.

As a result, the IGBT Q1 is maintained off, and the IGBT Q2 is maintained on, so that the input voltage Vin remains at the high level.

As described above, feedback control of the supply energy Wpv to the heating cylinder 12 is performed, and when the supply energy cumulative value Ipv is greater than the set supply energy cumulative value Isv, the inverter AN3 performs the skip operation, so that the operation of bringing the drive signals g1 and g2 to the high level or the low level is skipped. That is, each of the drive signals g1 and g2 is brought to the high level or the low level one time every two or more periods of the high frequency current supplied to the coil 16.

Accordingly, during that period, switching of the IGBTs Q1 and Q2 is not performed, so that the operation of bringing the input voltage Vin to the high level or the low level is skipped. Further, during that period, the inter-terminal voltage of the capacitor C3 decreases, so that the high frequency current supplied to the coil 16 decreases. As a result, the supply energy Wpv to the heating cylinder 12 can be decreased.

Next, a third embodiment of the present invention will be described. Notably, components having the same structures as those in the first embodiment are denoted by the same reference numerals, and their repeated descriptions are omitted. For the effect that the third embodiment yields through employment of the same structure, the description of the effect of the first embodiment is incorporated herein by reference.

FIG. 9 is a block diagram showing a main portion of an injection-molding-machine control apparatus according to a third embodiment of the present invention.

In this case, the induction heating apparatus 14 includes a coil 16 disposed on the heating cylinder 12, serving as a cylinder member; a heater driver 17 which generates high frequency current (current for induction heating) and supplies it to the coil 16; a temperature sensor (temperature detection section) 21 disposed on the heating cylinder 12 at a predetermined location so as to detect the temperature of the heating cylinder 12; a display setting unit 22 which serves as a display section and a setting section; and a control section 23 which reads a detection temperature Tpv; i.e., the temperature detected by means of the temperature sensor 21 and a set temperature Tsv; i.e., a target temperature of the heating cylinder 12 set by means of the display setting unit 22 and drives the heater driver 17 so as to perform feedback control.

The control section 23 includes a PID compensator 25, which calculates a proportional component, an integral component, and a derivative component on the basis of the difference ΔT between the detection temperature Tpv and the set temperature Tsv (ΔT=Tsv−Tpv), sets the set supply energy Wsv on the basis of the calculation result, and sends the set supply energy Wsv to a supply energy adjusting unit 29, which serves as a supply-energy adjustment processing means (processing section). The PID compensator 25 constitutes a set-supply-energy calculation processing means (processing section), and performs set-supply-energy calculation processing. Notably, although a signal used to send the set supply energy Wsv to the supply energy adjusting unit 29 may be a digital signal, the signal may be a train of pulses generated at a frequency proportional to the set supply energy Wsv.

Incidentally, in the above-described embodiments, since the detection voltage Vc (FIG. 1) is used as an electrical variable representing the state of the resonance circuit SR2 so as to generate the drive signals g1 and g2, the supply energies Wpv and P can be stabilized even when switching of the IGBTs Q1 and Q2, which serve as switching elements, is not skipped sufficiently. However, since the switching of the IGBTs Q1 and Q2 is not skipped sufficiently, the loss associated with switching of the IGBTs Q1 and Q2 increases. As a result, the heater driver 17 generates heat, and the reliability of the heater driver 17 decreases. In addition, the electrical power consumed at the induction heating apparatus 14 increases.

Next, there will be described a fourth embodiment of the present invention in which a derivative value dVc/dt of the detection voltage Vc is calculated as a voltage change rate δVc, and the voltage change rate δVc is used as an electrical variable so as to generate the drive signals g1 and g2. Notably, components having the same structures as those in the first embodiment are denoted by the same reference numerals, and their repeated descriptions are omitted. For the effect that the fourth embodiment yields through employment of the same structure, the description of the effect of the first embodiment is incorporated herein by reference.

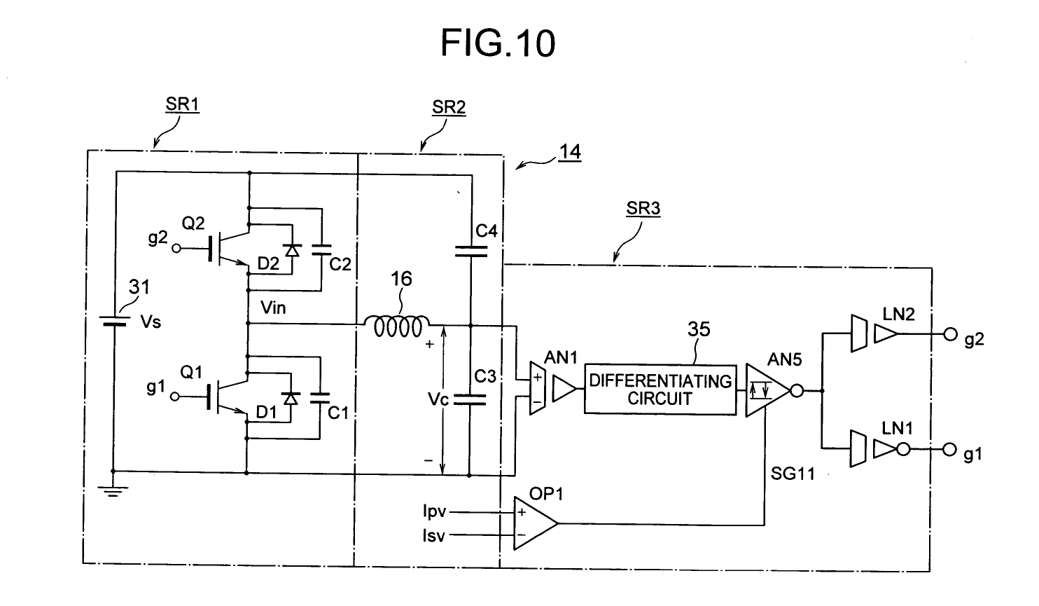

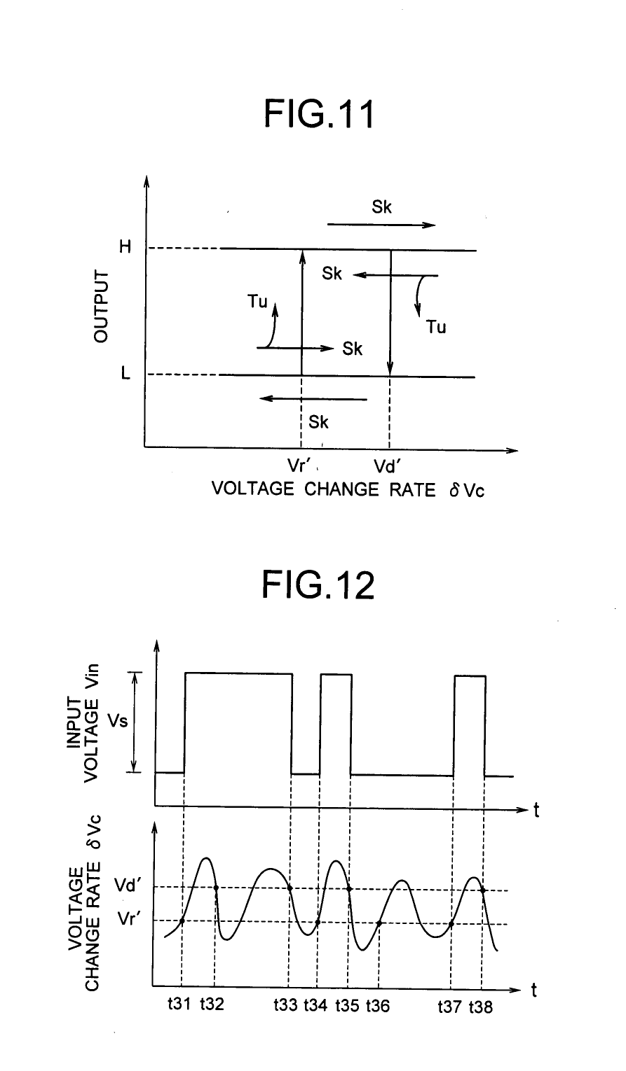

FIG. 10 is a conceptual diagram of an induction heating apparatus according to the fourth embodiment of the present invention. FIG. 11 is a diagram showing operation of an inverter in the fourth embodiment of the present invention. FIG. 12 is a time chart representing the relation between input voltage and voltage change rate of the induction heating apparatus according to the fourth embodiment of the present invention. Notably, in FIG. 11, the horizontal axis represents the voltage change rate δVc and the vertical axis represents the output.

In this case, a differentiating circuit 35, which serves as a voltage-change-rate calculation processing means (processing section), is connected to the output terminal of the voltage detection section AN1, which serves as an electrical variable detection section. The differentiating circuit 35 performs voltage-change-rate calculation processing so as to receive and differentiate the detection voltage Vc sent from the voltage detection section AN1 and serving as an electrical variable, calculates a derivative value dVc/dt as the voltage change rate δVc, and sends it to a buffer AN5, which serves as a drive-signal generation processing means (processing section).

The buffer AN5 has a skip function, and the output terminal of a comparator OP1, which servers as a supply-energy-cumulative-value determination processing means (processing section), is connected to the buffer AN5.

The buffer AN5, which performs drive-signal generation processing, receives the detection voltage Vc and the determination signal SG11, and operates in accordance with the operation characteristic as shown in FIG. 11.

First, in a case where the voltage change rate δVc decreases with the output being at the high level (H), the output remains at the high level until the voltage change rate δVc reaches a voltage change rate Vd′, which serves as a first threshold value. When the voltage change rate δVc reaches the voltage change rate Vd′, the buffer AN5 performs a turn operation (Tu) or a skip operation (Sk) depending on whether or not the determination signal SG11 is at the high level. That is, when the determination signal SG11 is at the low level, the buffer AN5 performs the turn operation, whereby the output changes from the high level to the low level (L), and remains at the low level after that point. Meanwhile, when the determination signal SG11 is at the high level, the buffer AN5 performs the skip operation, whereby the output remains at the high level. In a case where the voltage change rate δVc increases with the output being at the high level, the buffer AN5 performs the skip operation, whereby the output remains at the high level irrespective of the above-mentioned voltage change rate Vd′ and a voltage change rate Vr′, which is set to be smaller than the voltage change rate Vd′ and serves as a second threshold value.

Next, in a case where the voltage change rate δVc increases with the output being at the low level, the output remains at the low level until the voltage change rate δVc reaches the voltage change rate Vr′. When the voltage change rate δVc reaches the voltage change rate Vr′, the buffer AN5 performs the turn operation or the skip operation depending on whether or not the determination signal SG11 is at the high level. That is, when the determination signal SG11 is at the low level, the buffer AN5 performs the turn operation, whereby the output changes from the low level to the high level, and remains at the high level after that point. Meanwhile, when the determination signal SG11 is at the high level, the buffer AN5 performs the skip operation, whereby the output remains at the low level. In a case where the voltage change rate δVc decreases with the output being at the low level, the buffer AN5 performs the skip operation, whereby the output remains at the low level irrespective of the above-mentioned voltage change rates Vd′ and Vr′.

Accordingly, since the buffer AN5 performs the turn operation when the determination signal SG11 is at the low level, as shown in FIG. 12, when the voltage change rate δVc gradually increases and reaches the voltage change rate Vr′′ at timing t31 (t34, t37), the output of the buffer AN5 assumes the high level, the drive signal g1, which is the output of the first buffer LN1, assumes the low level, and the drive signal g2, which is the output of the second buffer LN2, assumes the high level.

As a result, the IGBT Q1, serving as a switching element, is turned off, and the IGBT Q2, serving as a switching element, is turned on, so that the input voltage. Vin changes from the low level to the high level, the capacitor C4 is discharged, and the capacitor C3 is charged, during which current flows through the coil 16 via the IGBT Q2. The inter-terminal voltage of the capacitor C3 and the detection voltage Vc increase gradually after having reached a bottom value. The voltage change rate δVc decreases gradually after having reached a peak value.

Meanwhile, in the case where the determination signal SG11 is at the low level, when the voltage change rate δVc gradually decreases and reaches the voltage change rate Vd′ at timing t33 (t35, t38), the output of the buffer AN5 assumes the low level, the drive signal g1 assumes the high level, and the drive signal g2 assumes the low level.

As a result, the IGBT Q1 is turned on, and the IGBT Q2 is turned off, so that the input voltage Vin changes from the high level to the low level, the capacitor C3 is discharged, and the capacitor C4 is charged, during which current flows through the coil 16 via the IGBT Q1. The inter-terminal voltage of the capacitor C3 and the detection voltage Vc decrease gradually after having reached a peak value. The voltage change rate δVc increases gradually after having reached a bottom value.

In contrast, since the buffer AN5 performs the skip operation when the determination signal SG11 is at the high level, even when the voltage change rate δVc gradually increases and reaches the voltage change rate Vr′ at timing t36, the output of the buffer AN5 does not change to the high level and remains at the low level. Thus, the drive signal g1 remains at the high level, and the drive signal g2 remains at the low level.

As a result, the IGBT Q1 is maintained on, and the IGBT Q2 is maintained off, so that the input voltage Vin remains at the low level.

Further, in a case where the determination signal SG11 is at the high level, even when the voltage change rate δVc gradually decreases and reaches the voltage change rate Vd′ at timing t32, the output of the buffer AN5 remains at the high level. Thus, the drive signal g1 remains at the low level, and the drive signal g2 remains at the high level.

As a result, the IGBT Q1 is maintained off, and the IGBT Q2 is maintained on, so that the input voltage Vin remains at the high level.

As described above, feedback control of the supply energy Wpv to the heating cylinder 12 is performed, and when the supply energy cumulative value Ipv is greater than the set supply energy cumulative value Isv, the buffer AN5 performs the skip operation, so that the operation of bringing the drive signals g1 and g2 to the high level or the low level is skipped. That is, each of the drive signals g1 and g2 is brought to the high level or the low level one time every two or more periods of the high frequency current supplied to the coil 16.

Accordingly, during that period, switching of the IGBTs Q1 and Q2 is not performed, so that the operation of bringing the input voltage Vin to the high level or the low level is skipped. Further, during that period, the inter-terminal voltage of the capacitor C3 decreases, so that the high frequency current supplied to the coil 16 decreases. As a result, the supply energy Wpv to the heating cylinder 12 can be decreased.

In the present embodiment, since the voltage change rate δVc is used as an electrical variable representing the state of the resonance circuit SR2 so as to generate the drive signals g1 and g2, switching of the IGBTs Q1 and Q2 is skipped sufficiently.

Accordingly, the loss associated with switching of the IGBTs Q1 and Q2 decreases, and it becomes possible to prevent the heat generation of the heater driver 17 and lowering of the reliability of the heater driver 17. In addition, the electrical power consumed at the induction heating apparatus 14 can be reduced.

Incidentally, in the present embodiment, the voltage change rate δVc is used as an electrical variable. When the current flowing through the coil 16 is represented by IL, the current IL can be represented as follows.
IL=C·dVc/dt
C: constant
   That is, the voltage change rate δVc is proportional to the current IL.

Next, there will be described a fifth embodiment of the present invention in which the current IL flowing through the coil 16 is detected, and the drive signals g1 and g2 are generated on the basis of the current IL. Notably, components having the same structures as those in the fourth embodiment are denoted by the same reference numerals, and their repeated descriptions are omitted. For the effect that the fifth embodiment yields through employment of the same structure, the description of the effect of the fourth embodiment is incorporated herein by reference.

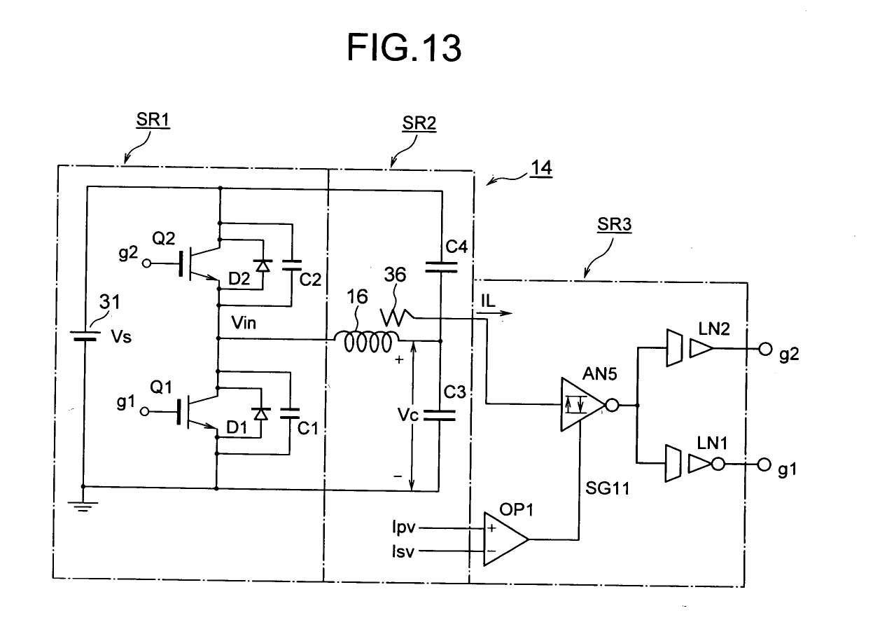

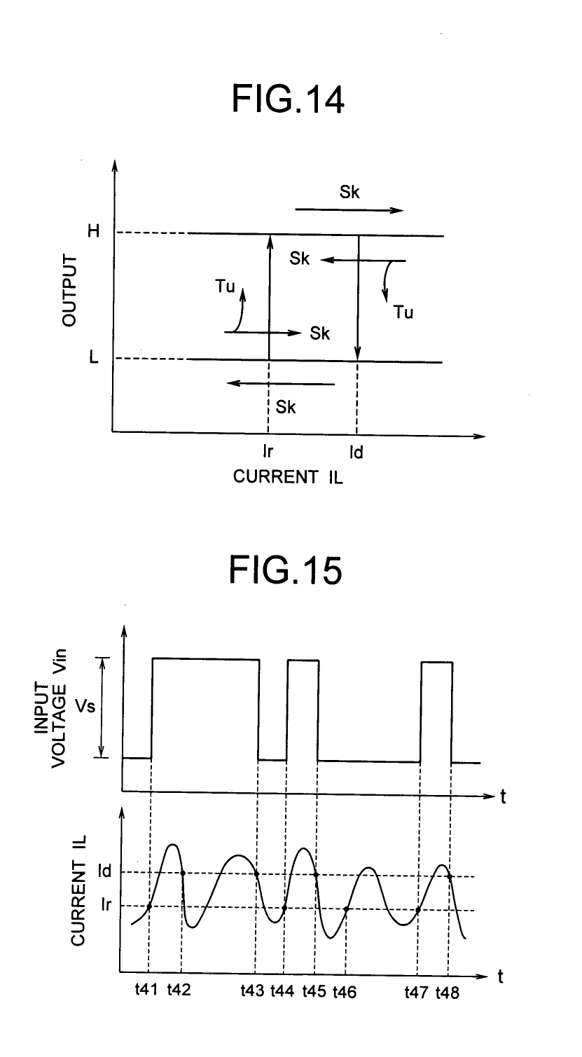

FIG. 13 is a conceptual diagram of an induction heating apparatus according to the fifth embodiment of the present invention. FIG. 14 is a diagram showing operation of an inverter in the fifth embodiment of the present invention. FIG. 15 is a time chart representing the relation between input voltage and current of the induction heating apparatus according to the fifth embodiment of the present invention. Notably, in FIG. 14, the horizontal axis represents the current IL and the vertical axis represents the output.

In FIG. 13, a reference numeral 36 denotes a current sensor which serves as an electrical variable detection section. The current sensor 36 detects the current IL flowing through the coil 16 as an electrical variable and sends it to a buffer AN5, which serves as a drive-signal generation processing means (processing section).

The buffer AN5, which performs drive-signal generation processing, receives the current IL and the determination signal SG11, and operates in accordance with the operation characteristic as shown in FIG. 14.

First, in a case where the current IL decreases with the output being at the high level (H), the output remains at the high level until the current IL reaches a current Id, which serves as a first threshold value. When the current IL reaches a current Id, the buffer AN5 performs a turn operation (Tu) or a skip operation (Sk) depending on whether or not the determination signal SG11 is at the high level. That is, when the determination signal SG11 is at the low level, the buffer AN5 performs the turn operation, whereby the output changes from the high level to the low level (L), and remains at the low level after that point. Meanwhile, when the determination signal SG11 is at the high level, the buffer AN5 performs the skip operation, whereby the output remains at the high level. In a case where the current IL increases with the output being at the high level, the buffer AN5 performs the skip operation, whereby the output remains at the high level irrespective of the above-mentioned current Id and a current Ir, which is set to be smaller than the current Id and serves as a second threshold value.

Next, in a case where the current IL increases with the output being at the low level, the output remains at the low level until the current IL reaches the current Ir. When the current IL reaches the current Ir, the buffer AN5 performs the turn operation or the skip operation depending on whether or not the determination signal SG11 is at the high level. That is, when the determination signal SG11 is at the low level, the buffer AN5 performs the turn operation, whereby the output changes from the low level to the high level, and remains at the high level after that point. Meanwhile, when the determination signal SG11 is at the high level, the buffer AN5 performs the skip operation, whereby the output remains at the low level. In a case where the current IL decreases with the output being at the low level, the buffer AN5 performs the skip operation, whereby the output remains at the low level irrespective of the above-mentioned currents Id and Ir.

Accordingly, since the buffer AN5 performs the turn operation when the determination signal SG11 is at the low level, as shown in FIG. 15, when the current IL gradually increases and reaches the current Ir at timing t41 (t44, t47), the output of the buffer AN5 assumes the high level, the drive signal g1, which is the output of the first buffer LN1, assumes the low level, and the drive signal g2, which is the output of the second buffer LN2, assumes the high level.

As a result, the IGBT Q1, serving as a switching element, is turned off, and the IGBT Q2, serving as a switching element, is turned on, so that the input voltage Vin changes from the low level to the high level, the capacitor C4 is discharged, and the capacitor C3 is charged, during which current flows through the coil 16 via the IGBT Q2. The inter-terminal voltage of the capacitor C3 increases gradually after having reached a bottom value, and the current IL decreases gradually after having reached a peak value.

Meanwhile, in the case where the determination signal SG11 is at the low level, when the current IL gradually decreases and reaches the current Id at timing t43 (t45, t48), the output of the buffer AN5 assumes the low level, the drive signal g1 assumes the high level, and the drive signal g2 assumes the low level.

As a result, the IGBT Q1 is turned on, and the IGBT Q2 is turned off, so that the input voltage Vin changes from the high level to the low level, the capacitor C3 is discharged, and the capacitor C4 is charged, during which current flows through the coil 16 via the IGBT Q1. The inter-terminal voltage of the capacitor C3 decreases gradually after having reached a peak value, and the current IL increases gradually after having reached a bottom value.

In contrast, since the buffer AN5 performs the skip operation when the determination signal SG11 is at the high level, even when the current IL gradually increases and reaches the current Ir at timing t46, the output of the buffer AN5 does not change to the high level and remains at the low level. Thus, the drive signal g1 remains at the high level, and the drive signal g2 remains at the low level.

As a result, the IGBT Q1 is maintained on, and the IGBT Q2 is maintained off, so that the input voltage Vin remains at the low level.

Further, in a case where the determination signal SG11 is at the high level, even when the current IL gradually decreases and reaches the current Id at timing t42, the output of the buffer AN5 remains at the high level. Thus, the drive signal g1 remains at the low level, and the drive signal g2 remains at the high level.

As a result, the IGBT Q1 is maintained off, and the IGBT Q2 is maintained on, so that the input voltage Vin remains at the high level.

In the present embodiment, the control section 23 is provided independently of the control section of the injection molding machine; however, the control section 23 may be incorporated into the control section of the injection molding machine.

The present invention is not limited to the above-described embodiments. Numerous modifications and variations of the present invention are possible in light of the spirit of the present invention, and they are not excluded from the scope of the present invention.

### INDUSTRIAL APPLICABILITY

The present invention is applicable to control apparatuses of injection-molding machines.

1. A molding-machine supply-energy calculation apparatus characterized by comprising:
(a) a high-frequency-current generation circuit including a coil disposed on a cylinder member, a DC voltage generation circuit, a switching element, and a capacitor, and adapted to generate high frequency current through switching of the switching element and supply the current to the coil;
(b) an electrical variable detection section that detects an electrical variable representing a state of a resonance circuit formed by the coil and the capacitor;
(c) drive-signal generation processing section that generates a drive signal driving the switching element on the basis of the electrical variable; and
(d) supply-energy calculation processing section that calculates a supply energy to the cylinder member on the basis of a voltage generated by the DC voltage generation circuit, a capacitance of the capacitor, and the electrical variable.

2. A molding-machine supply-energy calculation apparatus according to claim 1, wherein the supply-energy calculation processing means calculates the supply energy on the basis of a supply-energy calculation variable set on the basis of the electrical variable.

3. A molding-machine supply-energy calculation apparatus according to claim 2, wherein the supply energy is calculated by the following equation:
Wpv=ΣVs·C·(Vd−Vr)
where Wpv represents the supply energy, Vs represents the voltage generated by the DC voltage generation circuit, C represents the capacitance of the capacitor, and Vd and Vr each represent the supply-energy calculation variable.

4. A molding-machine supply-energy calculation apparatus according to claim 2, wherein the supply energy per unit time is calculated by the following equation:
P=f·Vs·C·(Vd−Vr)
where P represents the supply energy per unit time, f represents the base frequency of switching, Vs represents the voltage generated by the DC voltage generation circuit, C represents the capacitance of the capacitor, and Vd and Vr each represent the supply-energy calculation variable.

5. A molding-machine supply-energy calculation apparatus according to claim 2, wherein the supply energy is calculated by the following equation:
Wpv=ΣVs·C·(Vb−Vr)+ΣVs·C·(Vd−Vb)
where Wpv represents the supply energy, Vs represents the voltage generated by the DC voltage generation circuit, C represents the capacitance of the capacitor, Vd and Vr each represent the supply-energy calculation variable, and Vb represents a reference voltage.

6. A molding-machine supply-energy calculation apparatus according to claim 1, wherein the electrical variable is an inter-terminal voltage of the capacitor.

7. A molding-machine supply-energy calculation apparatus according to claim 1, wherein the electrical variable is the current flowing through the coil.

8. A molding machine control apparatus characterized by comprising:
(a) a cylinder member:
(b) a high-frequency-current generation circuit including a coil disposed on the cylinder member, a DC voltage generation circuit, a switching element, and a capacitor, and adapted to generate high frequency current through switching of the switching element and supply the current to the coil;
(c) an electrical variable detection section that detects an electrical variable representing a state of a resonance circuit formed by the coil and the capacitor;
(d) drive-signal generation processing section that generates a drive signal driving the switching element on the basis of the electrical variable;
(e) supply-energy calculation processing section that calculates a supply energy to the cylinder member on the basis of a voltage generated by the DC voltage generation circuit, a capacitance of the capacitor, and the electrical variable; and
(f) supply-energy-cumulative-value determination processing section that compares a supply energy cumulative value and a set supply energy cumulative value, wherein
(g) the drive-signal generation processing section generates the drive signal on the basis of the result of the comparison by the supply-energy-cumulative-value determination processing means.

9. A molding machine control apparatus characterized by comprising:
(a) a cylinder member:
(b) a high-frequency-current generation circuit including a coil disposed on the cylinder member, a DC voltage generation circuit, a switching element, and a capacitor, and adapted to generate high frequency current through switching of the switching element and supply the current to the coil;
(c) an electrical variable detection section that detects an electrical variable representing a state of a resonance circuit formed by the coil and the capacitor;
(d) drive-signal generation processing section that generates a drive signal driving the switching element on the basis of the electrical variable;
(e) supply-energy calculation processing section that calculates a supply energy to the cylinder member on the basis of a voltage generated by the DC voltage generation circuit, a capacitance of the capacitor, and the electrical variable;
(f) a temperature detection section that detects a temperature of the cylinder member; and
(g) set-supply-energy calculation processing section that calculates a set supply energy on the basis of the temperature detected by the temperature detection section.

10. A molding machine control method characterized by comprising:
(a) generating high frequency current in a high-frequency-current generation circuit including a coil disposed on a cylinder member, a DC voltage generation circuit, a switching element, and a capacitor, wherein the high frequency current is generated through switching of the switching element;
(b) detecting an electrical variable representing a state of a resonance circuit formed by the coil and the capacitor;
(c) generating a drive signal driving the switching element on the basis of the electrical variable;
(d) calculating a supply energy to the cylinder member on the basis of a voltage generated by the DC voltage generation circuit, a capacitance of the capacitor, and the electrical variable; and
(e) comparing a supply energy cumulative value and a set supply energy cumulative value, wherein
(f) the drive signal is generated on the basis of the result of the comparison between the supply energy cumulative value and the set supply energy cumulative value.
